(19) United States
(12) Patent Application Publication
(10) Pub. No.: US 2024/0261895 A1
(43) Pub. Date: Aug. 8, 2024

(54) System For Moving An Optical Element In A Laser Processing System

(71) Applicant: II-VI Delaware, Inc., Wilmington, DE (US)

(72) Inventors: Axel Heinrici, Wilmington, DE (US); Rutger Wevers, Wilmington, DE (US)

(21) Appl. No.: 18/428,860

(22) Filed: Jan. 31, 2024

(30) Foreign Application Priority Data
Feb. 6, 2023 (DE) 10 2023 000 481.2

(51) Int. Cl. B23K 26/06; B23K 26/70

(52) U.S. Cl. CPC B23K 26/0648; B23K 26/702

(57) ABSTRACT

The present disclosure relates generally to a mounting structure for a movable lens in a laser processing system for preventing vibration during movement of the lens. The present disclosure provides a system for moving an optical element comprising a frame, at least one optical element, and a drive for moving the at least one optical element, where the at least one optical element and the drive are connected to the frame via first and second spring members, respectively.

### CROSS-REFERENCE TO RELATED APPLICATION

The present application claims priority to German Patent Application No. DE 10 2023 000 481.2 filed on Feb. 6, 2023. The aforementioned application is hereby incorporated herein by reference in its entirety.

### FIELD OF THE DISCLOSURE

The present disclosure relates generally to a system having a mounting structure for a movable lens in a laser processing system for preventing vibration during movement of the lens.

### BACKGROUND OF THE DISCLOSURE

Laser processing systems are known and may comprise a large number of optical elements. In general, lenses that collimate or focus the laser beam are used in laser processing systems to shape the beam.

In laser processing such as laser cutting, laser welding or similar processes, the laser beam can be moved relative to an object. This movement takes place along a predefined path to create a seam or kerf and is therefore also referred to as path movement. The path movement takes place in the feed direction and can be superimposed by a second movement. This is a fast, high-frequency movement of a lens of the laser optics with the aim of moving the laser beam in order to achieve a larger surface area. This can be achieved, for example, by causing at least one lens of a laser processing optic to oscillate, so that the laser beam ultimately oscillates and a larger track width is generated for processing. The track width of the processed area is wider than the laser beam itself without so-called wobbling of a lens.

For example, when directed at the seam between the workpieces, the laser beam can have a diameter of 0.2 to 0.3 mm without wobbling. However, the laser beam can be oscillated at a frequency of e.g. 200 to 500 Hz transverse to the feed direction so that a track width of e.g. 0.6 to 1 mm is created. In these processes, the wobbling of the laser beam or a lens generates a larger track width, which reduces spattering during laser welding and makes it easier to bridge the gap. This process can also enable greater welding depths with moderate laser power

In laser beam wobbling for laser welding, the laser spot is moved at frequencies of more than 200 Hz. The published German patent application with the file number DE 10 2021 120 281 A1 discloses an arrangement for dynamic beam deflection and shaping for a laser machining process. In the arrangement disclosed in this document, the lens is moved at the frequencies mentioned.

A technical problem arises from the fact that even with a moving mass of only a few grams and a movement of 1/10 millimeter, a considerable vibration impulse is generated that can disturb or damage other parts of the welding head.

Methods for passively damping the movement of a lens in laser optics are known from the state of the art. Layers of a soft material are added to the carrier structure of the lens to be moved. These layers of soft material allow movement in undesirable directions, which results in movement restrictions. The disadvantage of such a solution is that it leads to poor positioning accuracy. Most passive damping methods require a high force to prevent oscillation.

Active damping of the movement of a lens in a laser optic is also known from the prior art. Active damping involves the addition of a further actively driven movable mass to compensate for the movement of the lens in the laser optics in order to prevent the movement of the lens from being transmitted to the laser optics. The movement of the additional movable element must be adjusted in such a way that the oscillation impulse of the lens in the laser optics is compensated. The disadvantages of this solution are the increased costs and the increasing complexity of the optical system and the mounting of the lens.

Further limitations and disadvantages of conventional and traditional approaches will become apparent to one of skill in the art, through comparison of such systems with some aspects of the present disclosure as set forth in the remainder of the present application with reference to the drawings.

### SUMMARY OF THE DISCLOSURE

The disclosure relates to a system having a mounting structure for a movable lens in a laser processing system for preventing vibration during movement of the lens, which overcomes disadvantages found in the prior art.

These and other advantages, aspects and novel features of the present disclosure, as well as details of an illustrated embodiment thereof, will be more fully understood from the following description and drawings.

### BRIEF DESCRIPTION OF THE DRAWINGS

The disclosure is illustrated in more detail below with reference to figures. It is obvious to the person skilled in the art that these are only possible, exemplary embodiments, without the disclosure being limited to the embodiments shown, wherein:

FIG. 1 shows a prior art device.

FIG. 2 shows a device for mounting a receptacle for a lens of a laser processing optic according to an example embodiment of the present disclosure.

### DETAILED DESCRIPTION OF THE DISCLOSURE

The present disclosure relates to an embodiment of laser optics in which the lens is moved by magnetic force. The magnetic coil is attached to the lens assembly, while the magnet is attached to the structure of the system. The spring, which holds the lens in the center position, provides a resonant frequency below the operating frequency (voice coil drive). The specialist can easily transfer the excitation to a moving magnet, piezo or other drive system.

The problem of transferring unwanted vibration impulses into the structure of the overall system is solved by the fact that the magnet is mounted on a movable holder with a spring that holds it in a central position or pulls it into this position.

The resonant frequency of the magnet-spring system is approximately the same as the resonant frequency of the lens-spring system and is therefore also lower than the operating frequency. The counterforce for the lens movement is balanced by the movement of the magnet and the movable magnet holder. The counterforce is not introduced directly into the structure. The only impulse transferred from the moving lens and magnet to the structure is the change in spring force due to the movement. The forces exerted by the two springs for mounting the magnetic coil on the lens and the magnet are directed in opposite directions. Ideally, the resonant frequency of the magnet-spring system matches the resonant frequency of the lens assembly-spring system. If the frequencies match exactly and there is no friction, the spring forces cancel each other out. The force on the magnet is not introduced into the structure, as is the case with permanently mounted magnets, but is largely compensated by the inertia and movement of the magnet.

The mass of the magnet is greater than the mass of the lens and the coil assembly. If the operating frequency is significantly higher than the resonant frequencies, the ratio of the movement amplitudes is the reciprocal of the mass ratio.

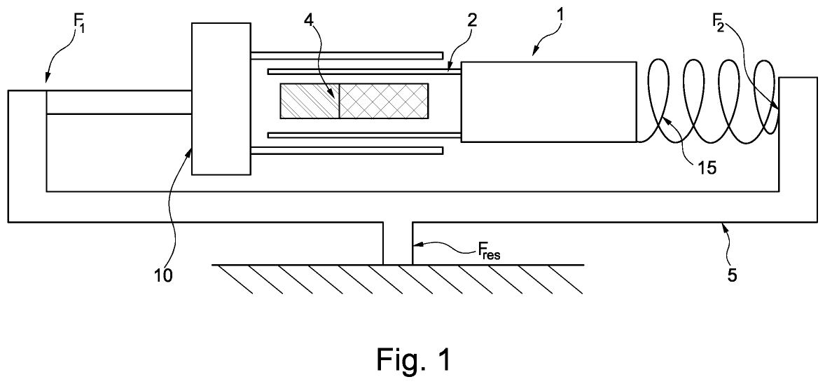

FIG. 1 shows an arrangement from the state of the art. Gravitational forces have been neglected in the following explanations. A current I flows through the coil 2, generating a force acting on the magnet 4 and coil 2. This is equal in absolute value and acts in the opposite direction. In the static case, i.e., when the current I is constant, the force F₁, which acts on the support structure, and the force F₂, which acts on the moving spring, cancel each other out, so according to Newton's 3rd law, the resulting force Fᵣₑₛ is equal to 0.

When oscillating at a frequency significantly higher than the resonance frequency of the moving mass, the coil force is mainly used in the movement of the moving mass (inertia) and not in the spring force of the moving mass. If F₂ is very small, it follows that F₁ corresponds to the magnetic force and then Fᵣₑₛis approximately equal to F₁. The decisive factor is that F₁ and F₂ compensate each other.

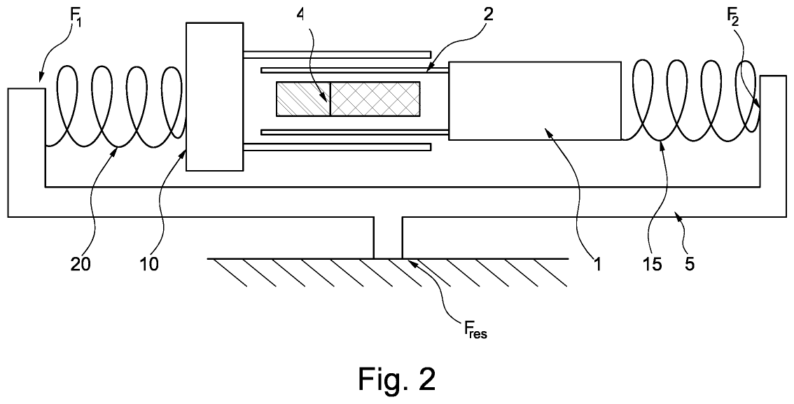

FIG. 2 shows a device according to the present disclosure. Here, the magnet holder is also connected to the support structure 5 via a spring. The device is constructed in such a way that the resonant frequencies of magnet 4 and lens 1 as the movable mass are approximately equal. When oscillating at a frequency that is significantly higher than the resonant frequencies of the movable mass, i.e., the lens 1 and the movable magnet 4, the coil and magnetic force are mainly incorporated into the inertia of the system and F₁ and F₂ largely cancel each other out.

If resonant frequencies and Q-factor match exactly, F₁ and F₂ are equal and therefore Fᵣₑₛ is equal to 0.

As long as the operating frequencies are well above the resonance frequencies, a reduction of Fᵣₑₛ by more than an order of magnitude can be achieved without precise tuning of the frequencies.

The technical effect and advantage of an arrangement according to the present disclosure is thus that vibrations acting on the support structure are largely avoided.

One aspect of the present disclosure is to provide a mounting structure for a movable optical element and an associated drive unit in a laser optic, which is suitable for avoiding the transmission of vibrations to the laser optic during wobbling.

The present disclosure provides a system for moving an optical element, comprising a frame, at least one optical element and a drive for moving the at least one optical element, wherein the at least one optical element and the drive are each connected to the frame via a first and second spring element.

In a further embodiment for a system according to the present disclosure, it is provided that the drive for moving the at least one optical element comprises at least one permanent magnet and at least one coil located in its magnetic field.

In a further aspect, in a system according to the present disclosure, the at least one coil may be arranged on the at least one optical element and the magnet may be arranged on a mounting structure which is connected to the frame via the second spring element.

According to the disclosure, it is further provided that the drive for moving the at least one optical element comprises two coils.

In an embodiment with two coils, a first of the two coils can be arranged on the at least one optical element and a second of the two coils can be arranged on a fastening structure, which is connected to the frame via the second spring element.

In one embodiment, a system according to the present disclosure may provide that the at least one optical element comprises a receptacle in which a lens or a group of lenses is arranged.

According to the disclosure, it can be provided that each coil present is connected to a current source in order to induce a magnetic field by applying a current.

In a further embodiment of a system according to the present disclosure, the drive for moving the at least one optical element may comprise a piezo element, wherein a part of the piezo element may be arranged on the at least one optical element and a second part of the piezo element is arranged on a mounting structure which is connected to the frame via the second spring element. Furthermore, the two parts of the piezo element can be connected to a power source.

The system according to the present disclosure may further comprise a connection of the power source to a control device for controlling the energization of the at least one coil or the parts of the piezo element.

In a further aspect of the present disclosure, it is provided that the at least one magnet comprises a plurality of magnets.

In one embodiment, the system comprises an optical element or a receptacle of the at least one optical element, which are configured such that they can each be moved transversely to the optical axis of a laser beam.

In a further embodiment of the disclosed system, the mount of the at least one optical element is rotatably arranged at an angle to the axis of a laser beam.

In a system according to the present disclosure, the at least one optical element may be a lens or a lens group.

Furthermore, the lenses or lens group can be lenses or lens groups of a collimator.

In a system according to the present disclosure, a resonant frequency of the first spring element may be selected such that it is equal to the resonant frequency of the second spring element.

Furthermore, in a system according to the present disclosure, the mass of the at least one magnet may be greater than the mass of the at least one optical element.

In a further embodiment of a system according to the present disclosure, first and/or second spring elements are formed by a coil spring, spring plates, leaf springs or groups and/or combinations thereof.

In the disclosed system, the frame may be the housing of a laser processing head.

Other aspects, features and advantages of the present disclosure will readily be apparent from the following detailed description, which simply illustrates preferred embodiments and implementations. The present disclosure may also be realized in other and different embodiments, and its various details may be modified in various obvious aspects without departing from the teachings and scope of the present disclosure. Accordingly, the drawings and descriptions are to be considered illustrative and not limiting. Additional features and advantages of the disclosure are set forth in part in the following description and will be apparent in part from the description or may be inferred from the embodiment of the disclosure.

What is claimed is:

1. A system for moving an optical element, comprising a frame, at least one optical element and a drive for moving the at least one optical element, wherein the at least one optical element and the drive are each connected to the frame via a first spring element and a second spring element.

2. The system according to claim 1, wherein the drive for moving the at least one optical element comprises at least one permanent magnet and at least one coil located in its magnetic field.

3. The system according to claim 1, wherein the at least one coil is arranged on the at least one optical element and the magnet is arranged on a mounting structure which is connected to the frame via the second spring element.

4. The system according to claim 1, wherein the drive for moving the at least one optical element comprises two coils.

5. The system according to claim 4, wherein a first one of the two coils is arranged on the at least one optical element and a second one of the two coils is arranged on a mounting structure which is connected to the frame via the second spring element.

6. The system according to claim 1, wherein the at least one optical element comprises a receptacle in which a lens or a group of lenses is arranged.

7. The system according to claim 2, wherein each coil present is connected to a current source to induce a magnetic field by applying a current.

8. The system according to claim 1, wherein the drive for moving the at least one optical element comprises a piezo element.

9. The system according to claim 8, wherein a part of the piezo element is arranged on the at least one optical element and a second part of the piezo element is arranged on a mounting structure which is connected to the frame via the second spring element.

10. The system according to claim 8, wherein the two parts of the piezo element are connected to a power source.

11. The system according to claim 7, wherein the current source is connected to a control device for controlling the energization of the at least one coil or the parts of the piezo element.

12. The system according to claim 2, wherein the at least one magnet comprises a plurality of magnets.

13. The system according to claim 1, wherein the optical element or the receptacle of the at least one optical element are configured such that they are each movable transversely to the optical axis of a laser beam.

14. The system according to claim 6, wherein the receptacle of the at least one optical element is rotatably arranged at an angle to the axis of a laser beam.

15. The system according to claim 1, wherein the at least one optical element is a lens or a lens group.

16. The system according to claim 15, wherein the lens or lens group are a lens or a lens groups of a collimator.

17. The system according to claim 1, wherein a resonant frequency of the first spring element is selected such that it is equal to the resonant frequency of the second spring element.

18. The system according to claim 1, wherein the mass of the at least one magnet is greater than the mass of the at least one optical element.

19. The system according to claim 1, wherein the first spring element and/or the second spring element are formed by a coil spring, spring plates, leaf springs or groups and/or combinations thereof.

20. The system according to claim 1, wherein the frame is the housing of a laser processing head.
